(19) United States
(12) Patent Application Publication
(10) Pub. No.: US 2004/0170531 A1
(43) Pub. Date: Sep. 2, 2004

(54) Gas chromatograph

(75) Inventor: Friedhelm Mueller, Linkenheim-Hochstetten (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AG

(21) Appl. No.: 10/732,364

(22) Filed: Dec. 11, 2003

Related U.S. Application Data
(63) Continuation of application No. PCT/DE02/02134, filed on Jun. 11, 2002.

(30) Foreign Application Priority Data
Jun. 11, 2001 (DE) 101 28 157.9

(51) Int. Cl. G01N 30/02

(52) U.S. Cl. 422/89

(57) ABSTRACT

A gas chromatograph with a chromatography unit (1) for chromatographic separation and analysis of a sample (2) and with a supply unit (3) that supplies the chromatography unit (1) at least with the sample (2) and with carrier gas (4). The two units (1, 3) can be interconnected via a connection interface (7), which is equipped with a gas connector (8) for the sample (2) supplied to the chromatography unit (1), a gas connector (9) for the carrier gas (4) supplied to the chromatography unit (1) and a sealing chamber (14) receiving the gas connectors (8, 9). The sealing chamber is purged with the carrier gas (4′, 4″, 4′″) that is used in the chromatography unit (1) for separation and is provided with an outlet (22) for the carrier gas (4, 4″, 4′″).

This is a Continuation of International Application PCT/DE02/02134, with an international filing date of Jun. 11, 2002, which was published under PCT Article 21(2) in German, and the disclosure of which is incorporated into this application by reference.

### FIELD OF AND BACKGROUND OF THE INVENTION

The invention relates to a gas chromatograph.

This gas chromatograph is to have a modular structure, such that the modular units can be separated or connected even under harsh process conditions without the gas conducting connections between the modular units having to be checked for leaks each time.

Chromatographic systems must be very tightly sealed, to prevent the sample from leaking out between injection and detection or from taking a path different from the one planned, and to prevent external gases, e.g. air, from entering into the system, all of which would tend to distort the analytical results.

German Patent DE 195 46 952 C2 discloses a gas analyzer plug-in arrangement in which different gas analyzers—mentioned are non-dispersive infrared (NDIR) gas analyzers, chemoluminescence gas analyzers (CLAs) and hydrogen flame ionization detectors (FIDs)—can be connected via connection interfaces to a rack that receives the gas analyzers. The connection interfaces each have electrical connections, consisting of a plug and a jack, and gas connections. One of the gas connections conducting the exhaust of the respective gas analyzer is configured in such a way that it forms a sealing chamber receiving the remaining gas connections. This ensures that, in case of a leak in one of the inner gas connections, the escaping gas is properly disposed of together with the exhaust from the gas analyzer and does not reach the environment in an uncontrolled manner.

### OBJECTS OF AND SUMMARY OF THE INVENTION

To achieve the initially described modular structure while meeting the sealing requirements, the gas chromatograph, according to one formulation of the invention, has a chromatography unit for the chromatographic separation and analysis of a sample and a supply unit for supplying the chromatography unit at least with the sample and with carrier gas. The two units can be interconnected via a connection interface, which has a gas connector for the sample supplied to the chromatography unit, a gas connector for the carrier gas supplied to the chromatography unit, and a sealing chamber for receiving the gas connectors. The sealing chamber is purged with the carrier gas used for the separation in the chromatography unit and has an outlet for this carrier gas. The connection interface of the gas chromatograph according to the invention can have a single, or indeed two or more, gas connectors for each of the sample and/or the carrier gas, as well as additional gas connectors, e.g. for control air.

Purging the sealing chamber with the carrier gas that is used in the chromatography unit for chromatographic separation prevents ambient air from getting into the chromatographic system in the area of the gas connectors. Due to the high diffusion pressure, even very small leaks can lead to considerable diffusion into the system if air is present in the area of the gas connectors and the carrier gas supplied to the chromatography unit consists of highly pure hydrogen, helium, nitrogen, etc., as is typically the case. Although sample components dosed into the unit for chromatographic separation sporadically get into the sealing chamber together with the carrier gas coming out of the chromatography unit, their amounts are negligible relative to the amount of carrier gas. As a result, there is practically no diffusion pressure in the area of the gas connectors, such that the chromatograph still works without interference even if there are minor leaks. The carrier gas consumption remains unchanged; it is not increased by the purging.

For liquid samples, the supply unit preferably has a sample evaporator and supplies the chromatography unit with the evaporated sample.

### BRIEF DESCRIPTION OF THE DRAWINGS

The invention will now be described in greater detail with reference to the drawing in which:

FIG. 1 is a schematic of an exemplary embodiment of the gas chromatograph according to the invention and

FIG. 2 is an exemplary embodiment of the gas connectors used.

### DETAILED DESCRIPTION OF THE PREFERRED EMBODIMENTS

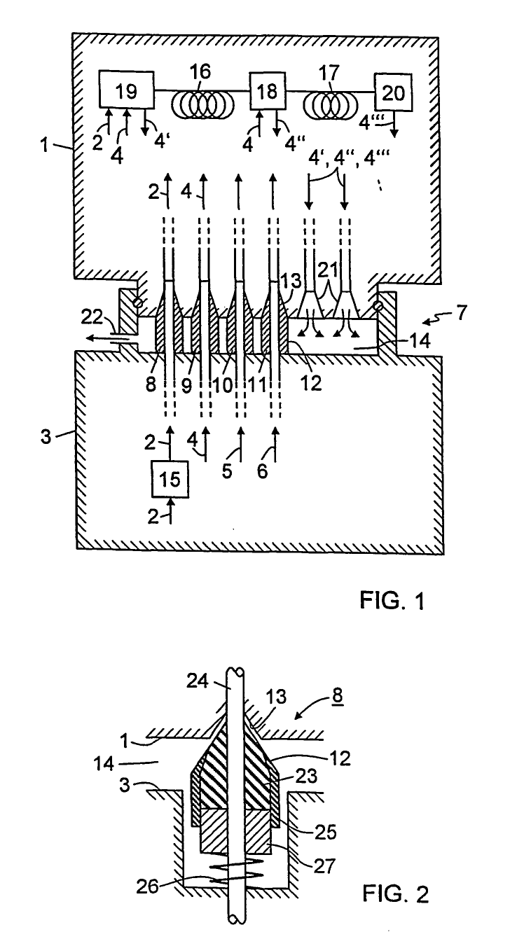

The gas chromatograph shown in FIG. 1 has a chromatography unit 1 for chromatographic separation and analysis of a sample 2 and a supply unit 3 for supplying the chromatography unit 1 with the sample 2, with carrier gas 4 and optionally with an auxiliary gas 5 and with control air 6. The two units 1 and 3 are interconnected via a connection interface 7, which has a gas connector 8 for the sample 2 supplied to the chromatography unit 1, a gas connector 9 for the carrier gas 4 supplied to the chromatography unit 1 and additional gas connectors 10 and 11 for the auxiliary gas 5 and the control air 6, respectively. The gas connectors 8-11 each is made of a plug 12 and a receptacle 13 such that each gas connector 8-11, when assembled, forms a tight unit. The connection interface 7 is further configured in such a way that, when the two units 1 and 3 are joined, a sealing chamber 14 is formed, which receives the gas connectors 8-11.

If the sample 2 is a liquid, it is evaporated in a sample evaporator 15 in the supply unit 3 before it is supplied to the chromatography unit 1 via the gas connector 8. In the example shown here, the chromatography unit 1 has a separation device that includes a precolumn 16 and an analytical column 17 interconnected via a switching device 18. The evaporated sample 2 is dosed in a dosing device 19 to form a sample plug, which is then supplied to the precolumn 16 by means of the carrier gas 4. The switching device 18 transfers the sample components that are to be measured and are still incompletely separated at the end of the precolumn 16 to the analytical column 17 and backflushes the boiling sample components that do not need to be measured and remain in the precolumn 16 with the carrier gas 4. At the end of the analytical column 17, the sample components, which are now completely separated, are analyzed in a detector and analysis unit 20. The carrier gas 4′, 4″, 4′″ coming out of the separation device is guided via sleeves 21 into the sealing chamber 14, which is purged by the carrier gas before the gas leaves through an outlet 22. In this process, each of the mutually separate gas connectors 8-11 is individually purged by the carrier gas 4′, 4″, 4′″.

As a variant of the configuration shown, the outlet 22 can instead or also lead to the supply unit 3. Furthermore, two or more gas connectors each can be provided for the sample and the supply of carrier gas. It is also possible to provide gas connectors for discharging gases from the chromatography unit 1 into the supply unit 3. In addition to supplying and discharging the gas, the supply unit 3 can also supply the chromatography unit 1 with electric power.

FIG. 2 shows a preferred structure of the gas connectors 8-11, using the example of the gas connector 8 in the sealing chamber 14 between the units 1 and 3. The plug 12 of the gas connector 8 has a conical part 23 made of PTFE or graphite and holding the capillary 24 carrying the sample 2. The conical part 23 is held in a sleeve 25 and is pushed into the receptacle 13 by means of a spring 26 via a thrust piece 27, to provide a conical seal.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A gas chromatograph, comprising:
a chromatography unit chromatographically separating and analyzing a sample;
a supply unit supplying the chromatography unit at least with the sample and with carrier gas; and
a connection interface interconnecting the chromatography unit and the supply unit, the connection interface comprising:
a gas connector for the sample supplied to the chromatography unit,
a gas connector for the carrier gas supplied to the chromatography unit, and
a sealing chamber, which receives the gas connectors and is purged with the carrier gas that is used for the chromatographic separation in the chromatography unit, and which comprises an outlet for the carrier gas.

2. The gas chromatograph as claimed in claim 1, wherein the sample comprises a liquid sample, the supply unit comprises a sample evaporator, and the supply unit supplies the evaporated sample to the chromatography unit.

3. The gas chromatograph as claimed in claim 1, wherein each of the gas connectors comprises a conical plug that holds a gas-conducting capillary and is pressed into a receptacle by the action of a spring.

4. A gas chromatograph, comprising:
a chromatography unit;
a supply unit supplying at least a sample to the chromatography unit; and
a connection interface interconnecting the chromatography unit and the supply unit, the connection interface comprising:
a first connector forming an entrance path for the sample from the supply unit to the chromatography unit,
a second connector forming an entrance path for a carrier to the chromatography unit,
a return path for the carrier from the chromatography unit, and
a sealing chamber housing the first and the second connectors and the return path,
wherein the return path is configured to discharge the carrier into the sealing chamber, and wherein the sealing chamber is configured with at least one outlet from the connection interface.

5. The gas chromatograph according to claim 4, wherein at least the first connector comprises:
a sample-conduction tube;
a plug configured to sealingly mate with a receptacle in the chromatography unit; and
a mechanism urging the plug against the receptacle when the connection interface interconnects the chromatography unit and the supply unit.

6. The gas chromatograph according to claim 4, wherein the mechanism comprises a spring.

7. The gas chromatograph according to claim 4, wherein the plug is conical.
